(19) United States
(12) Patent Application Publication
(10) Pub. No.: US 2003/0097902 A1
(43) Pub. Date: May 29, 2003

(54) Cam member and camshaft having same

(75) Inventors: Hiroshi Takiguchi, Shimotsuga-gun (JP); Takeshi Kuwahara, Shimotsuga-gun (JP)

Correspondence Address: PARKHURST & WENDEL, L.L.P., 1421 PRINCE STREET, SUITE 210, ALEXANDRIA, VA, 22314-2805, US

(73) Assignee: Nippon Piston Ring Co., Ltd., Saitama-shi (JP)

(21) Appl. No.: 10/200,117

(22) Filed: Jul. 23, 2002

(30) Foreign Application Priority Data
Jul. 31, 2001 (JP) P2001-231095
Apr. 25, 2002 (JP) P2002-123627

(51) Int. Cl. F16C 3/04

(52) U.S. Cl. 74/605

(57) ABSTRACT

A cam member of the present invention comprises solid lubricant having an average particle size of up to 100 μm in an amount of 0.5 vol. % to 3.0 vol. %. The solid lubricant is at least one selected from the group consisting of WS₂, CaF₂, BaF₂, BN, MnS, MoS₂, Cr₂O₃, MoO₃, B₂O₃ and MgSiO₃. The cam member is formed of a sintered alloy having a chemical composition comprising: C: from 1.5 to 3.8%; Cr: from 2.0 to 20.0%; Mo: from 0.5 to 3.0%; Si: from 0.2 to 1.0%; P: from 0.2 to 1.0%; Ni: up to 1.0% in volume; and the balance being Fe and incidental impurities. The sintered alloy has a matrix structure in which carbide is precipitated. The matrix structure mainly comprises pearlite.

### BACKGROUND OF THE INVENTION

1. Field of the Invention

The present invention relates to a cam member and a camshaft having such a cam member, which are used for an internal combustion engine, and particularly to the cam member, which has an excellent scuffing resistance required for the cam member to be subjected to sliding contact as well as an excellent pitting resistance required for the cam member to be subjected to rolling contact, and the camshaft on which such a cam member is provided.

2. Description of the Related Art

There has been a demand for decrease in the number of parts of an internal combustion engine to achieve the light weight. There have grown needs to develop a valve gear, which utilizes a direct-hitting type tappet to decrease the number of parts, so as to provide an intermediate sliding system between the sliding contact system and the rolling contact system, in addition to the above-mentioned demand.

The valve gear utilizing such a direct-hitting type tappet, does not make use of any rocker arm, thus making it possible to offer the total weight reduction of the valve gear. However, a cam-lifting distance by which the tappet operates becomes relatively larger than a cam-lifting distance in the other valve gear utilizing the rocker arm, causing possible problems on the sliding face between the cam member and the tappet.

More specifically, increase in the cam-lifting distance causes increase in contact pressure between the tappet and the cam member, resulting in problems that pitting may easily occur in the cam member. Consequently, the similar degree of pitting resistance to that required for the cam member to be subjected to the rolling contact is required even for the cam member, which has an excellent scuffing resistance and is to be subjected to the sliding contact. Use of the cam member, which has an excellent pitting resistance and is to be subjected to the rolling contact may cause problems of occurrence of initial scuff and abnormal abrasion due to increased contact pressure between the tappet and the cam member. In view of this fact, there is also required the similar degree of scuffing resistance to that required for the cam member to be subjected to the sliding contact.

The cam member, which is to be suitably applied to the intermediate sliding system between the sliding contact system and the rolling contact system, requires excellent properties of not only the scuffing resistance but also the pitting resistance.

In compliance with the above-described demand, a phosphate coating treatment (also called the “lubrite treatment”) or a steam treatment has conventionally been applied to the sliding faces of the cam member and the tappet to improve their sliding properties. In such a treatment, it is necessary to place a relatively long camshaft provided with cam members in a treating bath or a treating furnace to carry out the treatment. This causes a decreased number of camshafts, which are to be subjected to the treatment in a batch, thus leading to an increased manufacturing cost. In addition, the camshaft, which has already been machined into a shape having prescribed dimensions, is subjected to the treatment, leading to easy occurrence of a bend (i.e., distortion) after completion of the treatment. In such a case, there is required a subsequent step of correcting the bend, thus causing a problem.

### SUMMARY OF THE INVENTION

An object of the present invention, which wad made to meet the above-mentioned demand, is therefore to provide a cam member, which has an excellent scuffing resistance required for the cam member to be subjected to sliding contact as well as an excellent pitting resistance required for the cam member to be subjected to rolling contact, and a camshaft on which such a cam member is provided.

In order to attain the aforementioned object, the cam member of the present invention comprises solid lubricant having an average particle size of up to 100 μm in an amount of 0.5 vol. % to 3.0 vol. %.

According to the feature of the present invention, the cam member, which comprises the solid lubricant having an average particle size of up to 100 μm in an amount of 0.5 vol. % to 3.0 vol. %, permits to reduce coefficient of friction between the cam member and the counterpart, thus improving the sliding properties. As a result, it is possible to improve the scuffing resistance and the pitting resistance without carrying out any surface treatment as in the conventional prior art. In addition, the solid lubricant as included improves the machinability of the cam member. In the present invention having the above-mentioned feature, it is possible to impart not only excellent pitting resistance, but also excellent scuffing resistance to the cam member in the intermediate sliding system between the sliding contact system and the rolling contact system, thus being suitably applicable also to a sliding system in which the contact pressure with the counterpart is relatively high.

The above-mentioned lubricant may be at least one selected from the group consisting of WS₂, CaF₂, BaF₂, BN, MnS, MoS₂, Cr₂O₃, MoO₃, B₂O₃ and MgSiO₃.

The above-mentioned cam member may be formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: up to 1.0 vol. %; and

the balance being Fe and incidental impurities,

said sintered alloy having a matrix structure in which carbide is precipitated, said matrix structure mainly comprising pearlite.

The cam member of the present invention, which is formed of the sintered alloy having the above-mentioned chemical composition and the matrix structure in which carbide is precipitated, the matrix structure mainly comprising pearlite, has excellent sliding contact properties such as an excellent scuffing resistance, which is inherent in the cam member, as well as an excellent wear resistance and an excellent sticking resistance due to the above-mentioned solid lubricant. Consequently, it is possible to impart an excellent pitting resistance, which is required for the cam member to be subjected to the rolling contact, to the cam member that has an excellent scuffing resistance and is to be subjected to the sliding contact.

The above-mentioned cam member may be formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: from 1.0 vol. % to 2.5 vol. %; and

the balance being Fe and incidental impurities,

said sintered alloy having a matrix structure in which carbide is precipitated, said matrix structure mainly comprising martensite and bainite.

The cam member of the present invention, which is formed of the sintered alloy having the above-mentioned chemical composition and the matrix structure in which carbide is precipitated, the matrix structure mainly comprising martensite and bainite, has excellent rolling contact properties such as an excellent pitting resistance, which is inherent in the cam member, as well as an excellent wear resistance and an excellent sticking resistance due to the above-mentioned solid lubricant. Consequently, it is possible to impart an excellent scuffing resistance, which is required for the cam member to be subjected to the sliding contact, to the cam member that has an excellent pitting resistance and is to be subjected to the rolling contact.

In order to attain the aforementioned object, the camshaft of the present invention comprises:

a main shaft; and

at least one cam member provided on said main shaft,

wherein:

each of said at least one cam member comprises solid lubricant having an average particle size of up to 100 μm in an amount of 0.5 vol. % to 3.0 vol. %.

In case where the counterpart is a direct-hitting type tappet, a cam-lifting distance is relatively large so that contact pressure on the cam sliding surface increases. The camshaft of the present invention is provided with the cam member having an excellent scuffing resistance required for the cam member to be subjected to the sliding contact, as well as an excellent pitting resistance required for the cam member to be subjected to the rolling contact, thus being suitably applicable to the intermediate sliding system, in which the contact pressure with the counterpart is relatively high, between the sliding contact system and the rolling contact system

The additional features of the above-described cam member of the present invention may also be applied to the camshaft of the present invention.

More specifically, in the camshaft of the present invention, said solid lubricant may be at least one selected from the group consisting of WS₂, CaF₂, BaF₂, BN, MnS, MoS₂, Cr₂O₃, MoO₃, B₂O₃ and MgSiO₃.

Each of said at least one cam member may be formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: up to 1.0 vol. %; and

the balance being Fe and incidental impurities,

said sintered alloy having a matrix structure in which carbide is precipitated, said matrix structure mainly comprising pearlite.

Each of said at least one cam member may be formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: up to 1.0 vol. %; and

the balance being Fe and incidental impurities,

said sintered alloy having a matrix structure in which carbide is precipitated, said matrix structure mainly comprising martensite and bainite.

### BRIEF DESCRIPTION OF THE DRAWING

FIG. 1 is a plan view illustrating an embodiment of a camshaft on which the cam members of the present invention are provided.

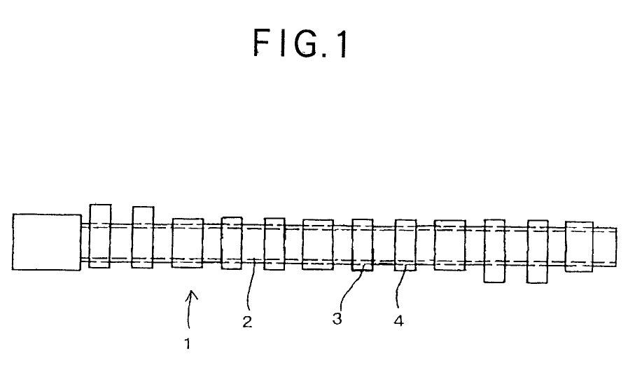

### DETAILED DESCRIPTION OF THE PREFERRED EMBODIMENTS

Now, embodiments of a cam member and a camshaft of the present invention will be described in detail below with reference to the accompanying drawing.

The cam member 1 of the present invention comprises solid lubricant having an average particle size of up to 100 μm in an amount of 0.5 vol. % to 3.0 vol. %. The cam member 1, which includes the above-mentioned solid lubricant, decreases coefficient of friction between the cam member 1 and the counterpart and improves the sliding properties. As a result, it is possible to improve the scuffing resistance and the pitting resistance without carrying out any surface treatment as in the conventional prior art. In addition, the solid lubricant as included improves the machinability of the cam member 1.

(1) Solid Lubricant

The solid lubricant is at least one selected from the group consisting of WS₂, CaF₂, BaF₂, BN, MnS, MoS₂, Cr₂O₃, MoO₃, B₂O₃ and MgSiO₃. Including such a solid lubricant in the cam member described below imparts to reduce coefficient of friction between the cam member and the counterpart, to improve the sliding properties. The sliding properties, which are improved under the functions of the solid lubricant, include sticking resistance and wear resistance. As the preferable solid lubricant to improve the sliding properties, there may be listed WS₂, BN, MnS and MoS₂. Including the solid lubricant in the cam member described below so as to be dispersed uniformly therein permits to improve the machinability of the cam member, thus making it possible to easily form the cam member into a prescribed shape.

It is preferable to limit the average particle size to up to 100 μm and an amount thereof within the range of from 0.5 vol. % to 3.0 vol. %.

With the average particle size of the solid lubricant of over 100 μm, hardness of the matrix decreases and the pitting resistance deteriorates, and a remarkably improving effect in the scuffing resistance is not provided. It is more preferable to limit the average particle size of the solid lubricant to up to 30 μm, thus making it possible to disperse more uniformly the solid lubricant in the matrix structure so as to improve remarkably the sticking resistance and the wear resistance. It is further more preferable to limit the average particle size of the solid lubricant to up to 10 μm. In the present invention, evaluation of the average particle size of the solid lubricant is made on the basis of measured results utilizing a laser diffusion method or a laser diffraction method. It is needless to say that the feature of the average particle size of the solid lubricant within the above-mentioned range, which is measured even by the other measuring method, is within the scope of the present invention.

With the content of the solid lubricant of under 0.5 vol. %, it is impossible to improve the sticking resistance and the wear resistance under the function of the solid lubricant, as well as the scuffing resistance, in some instances. With the content of the solid lubricant of over 3.0 vol. %, fatigue strength decreases and the pitting resistance and the corrosion resistance deteriorate, in some instances. It is more preferable to limit the content of the solid lubricant within the range of from 1.0 vol. % to 2.0 vol. %, thus providing a preferable sliding property.

The above-mentioned function of the solid lubricant is provided by the fact that the solid lubricant existing on the sliding surface of the cam member reduces coefficient of friction between the cam member and the counterpart. Even when the solid lubricant comes off the sliding surface of the cam member, such a solid lubricant exists between the sliding surface of the cam member and the counterpart, thus providing a function of preventing effectively occurrence of adhesion and sticking during the sliding contact. It is therefore possible to improve the running-in property in the initial sliding operation.

In the strict sense, it is preferable to select the most suitable solid lubricant in accordance with the kind or type of the counterpart to adopt the same. In addition, it is preferable to use the solid lubricant having a melting point of at least 1,200° C. The solid lubricant having the melting point of at least 1,200° C. uniformly disperses into the cam member when carrying out a sintering process described below. It is required that the inherent lubricating property of the solid lubricant does not change even through a sintering temperature applied to the cam member when carrying out the sintering process. The solid lubricant may be selected among the products supplied from the market, taking into consideration the king and average particle size of the solid lubricant, to adopt the same.

The cam member, which includes the above-mentioned solid lubricant in this manner, makes it possible to reduce coefficient of friction between the cam member and the counterpart so as to improve the sliding properties. It is therefore possible to impart an excellent scuffing resistance required for the cam member, which is to be subjected to the sliding contact, as well as an excellent pitting resistance required for the cam member, which is to be subjected to the rolling contact. Consequently, such a cam member is applicable to a severe sliding system in which the contact pressure between the cam member and the counterpart is relatively high.

Including the above-mentioned solid lubricant in the cam member described below so as to be uniformly dispersed therein provides the remarkably effective functions of the present invention as described above. The present invention includes the first cam member and the second cam member. The first cam member is formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: up to 1.0 vol. %; and

the balance being Fe and incidental impurities,

the sintered alloy having a matrix structure in which carbide is precipitated, the matrix structure mainly comprising pearlite. The second cam member is formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: from 1.0 vol. % to 2.5 vol. %; and

the balance being Fe and incidental impurities,

the sintered alloy having a matrix structure in which carbide is precipitated, the matrix structure mainly comprising martensite and bainite.

(2) First Cam Member

Description will be given below of the first cam member.

The first cam member is formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: up to 1.0 vol. %; and

the balance being Fe and incidental impurities,

the sintered alloy having a matrix structure in which carbide is precipitated, the matrix structure mainly comprising pearlite.

The first cam member is formed of the sintered alloy having an excellent wear resistance, in which fine deposited carbide is included in the matrix structure mainly comprising pearlite, so as to provide a good running-in property in the initial sliding operation and a good sliding property between the cam member and the counterpart, which are to be subjected to the sliding contact, as well as an excellent scuffing resistance (i.e., property of preventing effectively occurrence of sticking wear due to sliding friction even when the cam member and the counterpart are subjected to the sliding contact). In the present invention, there may be a case where the pearlite does not form the entirety of the matrix structure. In view of this fact, there is described that the matrix structure mainly comprises the pearlite. This however means the matrix structure of pearlite in general terms.

The first cam member of the present invention, which includes the solid lubricant, is provided by imparting an excellent pitting resistance with which the cam member to be subjected to the rolling contact is provided, to the cam member that has an excellent scuffing resistance and is subjected to the sliding contact. Thus obtained cam member is suitably applicable to the sliding system in which the contact pressure between the cam member and the counterpart is relatively high.

Now, the sintered alloy of which the first cam member is formed is described below. The sintered alloy has the matrix structure, which mainly comprises the pearlite having a good sliding property, and in which the carbide such as Cr carbide and Cr—Fe—Mo—P composite carbide is precipitated. An amount of austenite (also called the “retained austenite”) in the matrix structure (also called the “retained austenite content”) is up to 10 vol. %. Such a sintered alloy prevents the occurrence of initial scuff and provides an excellent running-in property in the initial sliding operation when the cam member and the counterpart are subjected to the sliding contact, on the one hand, and prevents the aggressiveness to the counterpart and provides an excellent wear resistance, on the other hand. In addition, a small content of the retained austenite having a low thermal conductivity in the matrix structure prevent degradation of the scuffing resistance due to the retained austenite.

Limiting the Ni content to up to 1.0 vol. % in the sintered alloy controls the retained austenite content in the matrix structure. With the Ni content of over 1.0 vol. %, sudden increase in the retained austenite content in the matrix structure tends to occur. Such a retained austenite may improve the wear resistance, but is not preferable to the scuffing resistance. With the retained austenite content of over 10 vol. % in the sintered alloy, scuff tends to easily occur in the counterpart formed of steel material. It is possible to prevent generation of the retained austenite and provide an excellent wear resistance and an excellent pitting resistance, even when Ni is not added. It is preferable to limit the Ni content to up to 1.0 vol. % in the sintered alloy.

Now, description will be given below of reasons for limiting the respective elements other than Ni, which are contained in the sintered alloy.

It is preferable to add C, which forms fine carbide having high hardness to provide a sufficient wear resistance and scuffing resistance, in an amount of at least 1.5 vol. %. With the C content of over 3.8 vol. %, coarse carbide (mainly Cr carbide) is however generated in the sintered alloy so that the coarse carbide forms relatively large pores in the sintered alloy in the liquid phase, thus causing embrittlement of the matrix structure. Accordingly, the C content is limited within the range of from 1.5 vol. % to 3.8 vol. %. It is preferable to limit the C content to a relatively large value within the range of from 2.0 vol. % to 3.8 vol. % and the Cr content to a relatively large value within the range of from 12.0 vol. % to 20.0 vol. %, in case where the sintered alloy is to be used under a high-loaded and high contact pressure condition.

The Cr content is adjusted within the range of from 2.0 vol. % to 20.0 vol. % in accordance with the mechanical properties of the counterpart. With the Cr content of over 20.0 vol. %, a function of making the Cr carbide fine is however lowered and hardness may become excessively high. With the Cr content of less than 2.0 vol. %, the Cr carbide becomes relatively coarse and there may be cases where the fine carbide cannot be precipitated in a sufficient amount and a sufficient wear resistance and a sufficient scuffing resistance cannot be provided. In view of these facts, the Cr content is limited within the range of from 2.0 vol. % to 20.0 vol. %. It is preferable to limit the Cr content to a relatively large value within the range of from 12.0 vol. % to 20.0 vol. % in association with the C content, in case where the sintered alloy is to be used under a high-loaded and high contact pressure condition.

Mo is added to increase the hardness of the matrix through the Mo′ dissolution therein and improve the wear resistance. However, addition of Mo even in amount of over 3.0 vol. % merely provides the above-mentioned effect to a certain extent. With the Mo content of less than 0.5 vol. %, the above-mentioned effect may not be provided sufficiently. In view of these facts, the Mo content is limited within the range of from 0.5 vol. % to 3.0 vol. %. Addition of Mo in an amount within the above-mentioned range does not exert any influence on the retained austenite content.

Si is an element having the function of facilitating generation of a liquid phase when the C and P contents are limited to relatively low values. With the Si content of less than 0.2 vol. %, there cannot be provided the function of facilitating generation of the liquid phase. Si, which is added as deoxidizer when manufacturing powdery material, may exist in the sintered alloy in a small amount. The lower limit of the Si content is set to 0.2 vol. %, taking into consideration the controllable range thereof. On the contrary, with the Si content of over 1.0 vol. %, there may be cases where embrittlement of the matrix occurs, formability of a green compact deteriorates and a degree of deformation of the sintered alloy after completion of the sintering process becomes large. In view of these facts, the Si content is limited within the range of from 0.2 vol. % to 1.0 vol. %.

Addition of P generates an Fe—C—P eutectic steadite. The steadite has an extremely high hardness and a relatively low melting point of about 950° C., thus facilitating liquid-phase sintering. With the P content of over 1.0 vol. %, there may be cases where the steadite is generated in an excessive amount and a proper machinability cannot be maintained even when the solid lubricant having the function of improving the machinability is added. With the P content of less than 0.2 vol. %, an amount of steadite as precipitated becomes smaller so that a high wear resistance cannot be provided and generation of the liquid phase is not facilitated. In view of these facts, the P content is limited within the range of from 0.2 vol. % to 1.0 vol. %.

At least one of Mn, B, V, Ti, Nb and W other than the above-described elements may be added in an appropriate amount, as an occasion demands. An object of addition of these elements is to facilitate generation of the liquid phase and formation of the carbide during the liquid-phase sintering process. It is preferable to add these elements in an appropriate amount within the range of from 0.1 vol. % to 5.0 vol. %, taking into consideration the hardness of the counterpart. In addition, Ca may be added in an amount of up to 300 ppm to improve the machinability. Addition of Mn in amount of up to 1.0 vol. % provides an effect of strengthening the matrix. With the Mn content of over 1.0 vol. %, progress of the sintering process is restricted so that the large pores are left as they are, thus degrading the formability of a green compact and the sintering property.

Now, description will be given below of a method for manufacturing the first cam member.

The method for manufacturing the first cam member comprises the steps of (i) adding metallic powder and the solid lubricant in their prescribed amounts to ferrous alloy powder, which includes iron powder serving as the main constituent and the other elements in prescribed amounts, so that the resultant chemical composition is in conformity with the above-mentioned ranges, to prepare powder for sintered alloy, (ii) subjecting the powder for sintered alloy to a press forming process to form a green compact having a prescribe shape in accordance with the conventional sintering method, and then (iii) subjecting the green compact to a sintering process utilizing the liquid-phase sintering treatment. It is preferable to add lubricant such as zinc stearate to the powder for sintered alloy, in order to facilitate operations of pressing the powder into a mold and removing the green compact from the mold. A treatment temperature of the liquid-phase sintering treatment is preferably limited within the range of from 1,100° C. to 1,200° C., and further preferably within the range of from 1,110° C. to 1,160° C. The sintering time is preferably limited within the range of from about 60 minutes to about 90 minutes. A tempering treatment may be carried out to adjust the properties of the first cam member, as an occasion demands.

In the manufacture of the first cam member, the first cam member and a main shaft may be diffusion-bonded firmly to each other through shrinkage and diffusion of the green compact during the liquid-phase sintering process of the green compact for the first cam member. More specifically, when a camshaft is composed of the main shaft and the first cam members, which are formed of the sintered alloy so as to be provided on the main shaft, a high density sintering treatment for the first cam members and a bonding treatment for fusion-bonding the first cam members onto the main shaft may be carried out simultaneously during the liquid-phase sintering treatment, to bond the first cam members firmly onto the main shaft.

(3) Second Cam Member

Description will be given below of the second cam member.

The second cam member is formed of a sintered alloy having a chemical composition comprising:

C: from 1.5 vol. % to 3.8 vol. %;

Cr: from 2.0 vol. % to 20.0 vol. %;

Mo: from 0.5 vol. % to 3.0 vol. %;

Si: from 0.2 vol. % to 1.0 vol. %;

P: from 0.2 vol. % to 1.0 vol. %;

Ni: from 1.0 vol. % to 2.5 vol. %; and

the balance being Fe and incidental impurities,

the sintered alloy having a matrix structure in which carbide is precipitated, the matrix structure mainly comprising martensite and bainite.

The second cam member provides a property of preventing effectively occurrence of surface flaws due to rolling fatigue between the cam member and the counterpart, which are to be subjected to the rolling contact (i.e., an excellent pitting resistance), as well as an excellent wear resistance. In the present invention, there may be a case where the martensite and the bainite do not form the entirety of the matrix structure. In view of this fact, there is described that the matrix structure mainly comprises the martensite and the bainite. This however means the matrix structure of martensite and bainite in general terms.

The second cam member of the present invention, which includes the solid lubricant, is obtained by imparting an excellent scuffing resistance with which the cam member to be subjected to the sliding contact is provided, to the cam member that has an excellent pitting resistance and is subjected to the rolling contact. Thus obtained cam member is suitably applicable to the sliding system in which the contact pressure between the cam member and the counterpart is relatively high.

Now, the sintered alloy of which the second cam member is formed is described below. The sintered alloy has the matrix structure, which is a martensite-bainite-retained austenite matrix mainly comprising martensite and bainite having a high strength and a high toughness. Precipitated carbide such as Cr carbide and Cr—Fe—Mo—P composite carbide is precipitated in the above-mentioned matrix structure, to provide an excellent wear resistance and an excellent pitting resistance. The sintered alloy, which is provided with the matrix structure of pearlite-bainite-retained austenite and has the similar characteristics, is also preferably applicable to the second cam member.

The second cam member formed of the sintered alloy differs from the first cam member only in that the Ni content is limited within the range of from over 1.0 vol. % to 2.5 vol. %. The Ni content of the second cam member of over 1.0 vol. % to 2.5 vol. % does not overlap with the Ni content of the first cam member of up to 1.0 vol. %. The sintered alloy for the second cam member has the matrix containing a large amount of retained austenite, due to the above-mentioned range of the Ni content. Accordingly, it is possible to provide a high toughness as well as an excellent fatigue resistance and an excellent wear resistance. Addition of Ni even in amount of over 2.5 vol. % does not provide a further improved effect. With the Ni content of up to 1.0 vol. %, the retained austenite content decreases to up to 10 vol. % and there may be a case where an excellent fatigue resistance and an excellent wear resistance required for the second cam member, which is to be subjected to the rolling contact, cannot be provided. In addition, the matrix structure is converted into the structure mainly comprising pearlite and there may be a case where an excellent pitting resistance required for the second cam member, which is to be subjected to the rolling contact. In view of these facts, the Ni content is limited within the range of from over 1.0 vol. % to 2.5 vol. %.

Functions of the elements other than Ni, contained in the sintered alloy, and reasons for limiting the ranges of these elements are similar to those in the sintered alloy for the first cam member. The method for manufacturing the second cam member is also the same as the method for manufacturing the first cam member.

When a further improvement in scuffing resistance of the second cam member is required, the Ni content is decreased to a slightly low value to increase the ratio of the pearlite in the matrix structure and decrease an amount of the retained austenite in the matrix structure, which causes occurrence of scuff. When there exist a significant requirement of improvement in pitting resistance, the Ni content is increased to a slightly high value to provide the matrix structure mainly comprising the martensite and the bainite, thus providing an excellent pitting resistance.

(4) Camshaft

The camshaft of the present invention comprises a main shaft 2 formed of a steel pipe and at least one set of the first cam members 3 and the second cam members 4, which are fitted in their prescribed positions on the main shaft 2 so as to provide their respective operational angles. A diffusion bonding method or a mechanical method through forcedly-insertion is preferably applied to join the cam members 3, 4 and the camshaft 2 to each other.

In the diffusion bonding method, green compacts for the first cam members 3 and/or green compacts for the second cam members 4 are fitted on the main shaft 2 in their prescribed positions so as to provide their prescribed operational angles, and these green compacts are subjected to the liquid-phase sintering treatment so as to liquid-phase sinter these green compacts to form the first cam members 3 and/or the second cam members 4, while diffusion-bonding these cam members 3 and/or 4 to the main shaft 2.

In the manufacture of the camshaft provided with the first cam members 3 and the second cam members 4, it is possible to sinter the green compacts for the first cam members 3 and the second cam members 4, which have the different chemical compositions from each other, at the same temperature, as well as carry out the diffusion bonding at the same temperature, thus providing advantage of most effectively manufacturing the camshaft.

In the method for manufacturing the cam member and the camshaft of the present invention, it is unnecessary to carry out a surface treatment such as a steam treatment to provide an excellent scuffing resistance, after the completion of the diffusion bonding treatment, thus making it possible to manufacture the camshaft effectively and at low costs in comparison with the conventional method.

The mechanical method through forcedly-insertion is to bond the cam members to the main shaft in accordance with the method as described in Japanese Laid-Open Application No. H5-10340. More specifically, a main shaft 2, which is formed of steel utilizing a rolling method so as to provide in its prescribed positions with projections, is forcedly inserted into the first cam members and/or the second cam members both as sintered, and the other cam members that are formed of sintered alloy having an excellent pitting resistance or steel, which has been subjected to a quenching treatment and a tempering treatment to provide an excellent pitting resistance, so that these cam members are placed in the prescribed order, providing their respective operational angles. The camshaft is manufactured in this manner.

In this case, as the above-mentioned cam members formed of steel, which has been subjected to the quenching treatment and the tempering treatment to provide an excellent pitting resistance, there may be used cam members, which are formed of steel such as S50C (carbon steel material), SCr (chrome steel material) or SCM (chrome-molybdenum steel material) that has been subjected to the quenching treatment and the tempering treatment to improve the mechanical properties, especially, the fatigue resistance. Conditions of the quenching treatment and the tempering treatment are determined in the conventional manner, taking into consideration the properties of the cam member to be obtained. The resultant cam member formed of steel, which has an excellent pitting resistance, is suitably applicable to a cam member, which is to be subjected to the rolling contact.

All of the first cam members, the second cam members and the other cam members formed of the above-mentioned steel that has been subjected to the quenching treatment and the tempering treatment to provide the excellent pitting resistance, are sufficiently strengthened and are excellent in tensile strength and fatigue strength. Consequently, the main shaft can be forcedly inserted into these cam members without causing occurrence of deviation of the cam members and cracks thereof, thus ensuring a reliable firm connection of the cam members to the main shaft.

The camshaft 1 of the present invention described above is provided with the cam members 3 and/or 4, which have the excellent scuffing resistance required for the cam member to be subjected to the sliding contact as well as the excellent pitting resistance required for the cam member to be subjected to the rolling contact. Consequently, the above-mentioned camshaft 1 is suitably applicable to the intermediate sliding system between the sliding contact system and the rolling contact system, having the high contact pressure with the counterpart.

### EXAMPLES

Examples of the cam member and the camshaft of the present invention will be described in detail below.

Sample of the Invention No. 1

Metallic elements were added to iron powder to prepare powdery material for the sintered alloy so that the chemical composition of the sintered alloy met the conditions of the contents as shown in Table 1. MnS, which had the average particle size of 40 μm and served as the solid lubricant, was added in an amount of 0.5 vol. %. Zinc stearate serving as mold releasing agent was added in an amount of 1 vol. %. The resultant powdery material was subjected to a mixing step.

TABLE 1

| SAMPLE | CHEMICAL COMPOSITION (volume %) | | | | | | | | SOLID LUBRICANT | | | SCUFFING | PITTING | |
|---|---|---|---|---|---|---|---|---|---|---|---|---|---|---|
| OF THE | | | | | | | | STRUC- | | PARTICLE | | RESIS- | RESIS- | MACHINA- |
| INVENTION | C | Cr | Mo | Si | P | Ni | Balance | TURE | KIND | SIZE | CONTENT | TANCE | TANCE | BILITY |
| 1 | 2.4 | 12.0 | 1.0 | 0.8 | 0.5 | 0.3 | Fe | P | MnS | 40 | 0.50 | ∘ | ∘ | ∘ |
| 2 | 2.4 | 12.0 | 1.0 | 0.8 | 0.5 | 0.3 | Fe | P | MnS | 40 | 0.75 | ∘ | ∘ | ∘ |
| 3 | 2.4 | 12.0 | 1.0 | 0.8 | 0.5 | 0.3 | Fe | P | MnS | 40 | 1.50 | ∘ | ∘ | ∘ |
| 4 | 2.4 | 12.0 | 1.0 | 0.8 | 0.5 | 0.3 | Fe | P | MnS | 40 | 3.00 | ∘ | ∘ | ∘ |
| 5 | 2.4 | 12.0 | 1.0 | 0.8 | 0.5 | 0.3 | Fe | P | MnS | 100 | 0.50 | ∘ | ∘ | ∘ |
| 6 | 2.4 | 12.0 | 1.0 | 0.8 | 0.5 | 0.3 | Fe | P | MnS | 100 | 1.50 | ∘ | ∘ | ∘ |
| 7 | 2.4 | 12.0 | 1.0 | 0.8 | 0.5 | 1.9 | Fe | M + B | MnS | 40 | 0.50 | ∘ | ∘ | ∘ |
| 8 | 2.4 | 12.0 | 1.0 | 0.8 | 0.5 | 1.9 | Fe | M + B | MnS | 40 | 0.75 | ∘ | ∘ | ∘ |
| 9 | 2.4 | 12.0 | 1.0 | 0.8 | 0.5 | 1.9 | Fe | M + B | MnS | 40 | 1.50 | ∘ | ∘ | ∘ |
| 10 | 2.4 | 12.0 | 1.0 | 0.8 | 0.5 | 1.9 | Fe | M + B | MnS | 40 | 3.00 | ∘ | ∘ | ∘ |
| 11 | 2.4 | 12.0 | 1.0 | 0.8 | 0.5 | 1.9 | Fe | M + B | MnS | 100 | 0.50 | ∘ | ∘ | ∘ |
| 12 | 2.4 | 12.0 | 1.0 | 0.8 | 0.5 | 1.9 | Fe | M + B | MnS | 100 | 1.50 | ∘ | ∘ | ∘ |
| 13 | 2.4 | 12.0 | 1.0 | 0.8 | 0.5 | 0.3 | Fe | P | WS₂ | 40 | 1.50 | ∘ | ∘ | ∘ |
| 14 | 2.4 | 12.0 | 1.0 | 0.8 | 0.5 | 0.3 | Fe | P | CaF₂ | 40 | 1.50 | ∘ | ∘ | ∘ |
| 15 | 2.4 | 12.0 | 1.0 | 0.8 | 0.5 | 0.3 | Fe | P | BaF₂ | 40 | 1.50 | ∘ | ∘ | ∘ |
| 16 | 2.4 | 12.0 | 1.0 | 0.8 | 0.5 | 0.3 | Fe | P | BN | 40 | 1.50 | ∘ | ∘ | ∘ |
| 17 | 2.4 | 12.0 | 1.0 | 0.8 | 0.5 | 0.3 | Fe | P | MoS₂ | 40 | 1.50 | ∘ | ∘ | ∘ |
| 18 | 2.4 | 12.0 | 1.0 | 0.8 | 0.5 | 0.3 | Fe | P | Cr₂O₃ | 40 | 1.50 | ∘ | ∘ | ∘ |
| 19 | 2.4 | 12.0 | 1.0 | 0.8 | 0.5 | 0.3 | Fe | P | MoO₃ | 40 | 1.50 | ∘ | ∘ | ∘ |
| 20 | 2.4 | 12.0 | 1.0 | 0.8 | 0.5 | 0.3 | Fe | P | B₂O₃ | 40 | 1.50 | ∘ | ∘ | ∘ |
| 21 | 2.4 | 12.0 | 1.0 | 0.8 | 0.5 | 0.3 | Fe | P | MgSiO₃ | 40 | 1.50 | ∘ | ∘ | ∘ |
| 22 | 2.4 | 12.0 | 1.0 | 0.8 | 0.5 | 0.3 | Fe | P | MnS + | 40 | 1.50 | ∘ | ∘ | ∘ |
| | | | | | | | | | MoS₂ | | | | | |
| 23 | 2.4 | 12.0 | 1.0 | 0.8 | 0.5 | 0.3 | Fe | P | MnS + | 40 | 1.50 | ∘ | ∘ | ∘ |
| | | | | | | | | | BN | | | | | |
| 24 | 2.6 | 8.0 | 2.0 | 0.8 | 0.5 | 1.9 | Fe | M + B | MnS | 40 | 1.50 | ∘ | ∘ | ∘ |
| 25 | 2.0 | 4.0 | 2.0 | 0.8 | 0.5 | 1.9 | Fe | M + B | MnS | 40 | 1.50 | ∘ | ∘ | ∘ |
| 26 | 2.4 | 12.0 | 1.0 | 0.8 | 0.5 | 0 | Fe | P | MnS | 40 | 1.50 | ∘ | ∘ | ∘ |
| 27 | 2.2 | 8.0 | 2.0 | 0.8 | 0.5 | 0.3 | Fe | P | MnS | 40 | 1.50 | ∘ | ∘ | ∘ |
| 28 | 2.0 | 4.0 | 1.0 | 0.8 | 0.5 | 1.0 | Fe | P | MnS | 40 | 1.50 | ∘ | ∘ | ∘ |

Note:
P: pearlite;
M + B: martensite + bainite,
particle size: average particle size (μm);
content: volume %

Then, the powdery material was subjected to a press-forming step at a pressure of from 5 t to 7 to/cm² to prepare green compacts for the cam members. The green compacts were then fitted on a main shaft formed of steel to prepare a united camshaft body (hereinafter refereed to as the “fitting step”). The united camshaft body was subjected to a sintering step to sinter the same at a temperature of from 1,100° C. to 1,200° C. (average temperature: 1,160° C.) in a vacuum furnace to prepare a sintered body having the matrix structure mainly comprising pearlite. The resultant sintered body was then subjected to a finishing machining step utilizing a cam-grinding machine to prepare the Sample of the invention No. 1 of the camshaft having the cam members of the present invention.

Samples of the Invention Nos. 2 to 28

Metallic elements, solid lubricant and mold releasing agent were added to iron powder to prepare powdery material for the sintered alloy so that the chemical composition of the sintered alloy met the conditions of the contents as shown in Table 1. Then, the press-forming step, the fitting step, the sintering step and the finishing machining step, which were the same as those in the Sample of the invention No. 1, were carried out to prepare the Samples of the invention Nos. 2 to 28 of the camshaft each having the cam members of the present invention.

Sample for Comparison No. 1

Metallic elements and mold releasing agent were added to iron powder to prepare powdery material for the sintered alloy so that the chemical composition of the sintered alloy met the conditions of the contents as shown in Table 2. Then, the press-forming step, the fitting step, the sintering step and the finishing machining step, which were the same as those in the Sample of the invention No. 1, were carried out to prepare the Sample for comparison No. 1 of the camshaft having the cam members for comparison.

TABLE 2

| SAMPLE | CHEMICAL COMPOSITION (volume %) | | | | | | | | SOLID LUBRICANT | | | SCUFFING | PITTING | |
|---|---|---|---|---|---|---|---|---|---|---|---|---|---|---|
| FOR COM- | | | | | | | | STRUC- | | PARTICLE | | RESIS- | RESIS- | MACHINA- |
| PARISON | C | Cr | Mo | Si | P | Ni | Balance | TURE | KIND | SIZE | CONTENT | TANCE | TANCE | BILITY |
| 1 | 2.4 | 12.0 | 1.0 | 0.8 | 0.5 | 0.3 | Fe | P | — | — | — | x | x | x |
| 2 | 2.4 | 12.0 | 1.0 | 0.8 | 0.5 | 0.3 | Fe | P | MnS | 150 | 1.50 | Δ | Δ | Δ |
| 3 | 2.4 | 12.0 | 1.0 | 0.8 | 0.5 | 0.3 | Fe | P | MnS | 40 | 0.25 | Δ | Δ | Δ |
| 4 | 2.4 | 12.0 | 1.0 | 0.8 | 0.5 | 0.3 | Fe | P | MoS | 40 | 4.00 | Δ | Δ | Δ |
| 5 | 2.4 | 12.0 | 1.0 | 0.8 | 0.5 | 0.3 | Fe | P | BN | 40 | 4.00 | Δ | Δ | Δ |
| 6 | 2.4 | 12.0 | 1.0 | 0.8 | 0.5 | 1.9 | Fe | M + B | — | — | — | x | x | x |
| 7 | 2.4 | 12.0 | 1.0 | 0.8 | 0.5 | 1.9 | Fe | M + B | MnS | 150 | 1.50 | Δ | Δ | Δ |
| 8 | 2.4 | 12.0 | 1.0 | 0.8 | 0.5 | 1.9 | Fe | M + B | MnS | 40 | 0.25 | Δ | Δ | Δ |
| 9 | 2.4 | 12.0 | 1.0 | 0.8 | 0.5 | 1.9 | Fe | M + B | MnS | 40 | 4.00 | Δ | Δ | Δ |
| 10 | 2.4 | 12.0 | 1.0 | 0.8 | 0.5 | 1.9 | Fe | M + B | BN | 150 | 1.50 | Δ | Δ | Δ |

| | | | | | | | | | | | | |
|---|---|---|---|---|---|---|---|---|---|---|---|---|
| 11 | 2.4 | 12.0 | 1.0 | 0.8 | 0.5 | 0.3 | Fe | P | PHOSPHATE COATING | Δ | Δ | x |
| 12 | 2.4 | 12.0 | 1.0 | 0.8 | 0.5 | 0.3 | Fe | P | STEAM TREATMENT | Δ | Δ | x |

Note:
P: pearlite;
M + B: martensite + bainite,
particle size: average particle size (μm);
content: volume %

Samples for Comparison Nos. 2 to 10

Metallic elements, solid lubricant and mold releasing agent were added to iron powder to prepare powdery material for the sintered alloy so that the chemical composition of the sintered alloy met the conditions of the contents as shown in Table 2. Then, the press-forming step, the fitting step, the sintering step and the finishing machining step, which were the same as those in the Sample of the invention No. 1, were carried out to prepare the Samples for comparison Nos. 2 to 10 of the camshaft having the cam members for comparison.

Samples for Comparison Nos. 11 and 12

Metallic elements and mold releasing agent were added to iron powder to prepare powdery material for the sintered alloy so that the chemical composition of the sintered alloy met the conditions of the contents as shown in Table 2. Then, the press-forming step, the fitting step, the sintering step and the finishing machining step, which were the same as those in the Sample of the invention No. 1, were carried out to prepare camshafts. The camshafts thus prepared were subjected to a phosphate coating treatment or a steam treatment to prepare the Samples for comparison Nos. 11 and 12 of the camshaft having the cam members for comparison.

Evaluation for the Samples

Tests were carried out for the Samples of the invention Nos. 1 to 28 and the Samples for comparison Nos. 1 to 12 to evaluate the scuffing resistance and the pitting resistance. Machinability of these samples was also evaluated on the basis of results of the finishing machining step, which was applied to the sintered alloy utilizing the cam-grinding machine.

In the test for the scuffing resistance, the samples were placed on a friction tester in an atmosphere under a high pressure, which was equivalent to pressure of an actually working engine. Load in such an atmosphere was gradually increased. The scuffing resistance was evaluated on the basis of a critical pressure associated with the load at which scuffing occurred. The test conditions are as follows:

| | |
|---|---|
| (1) Material of the counterpart: | SCM415 carburized steel product |
| (2) Number of revolutions: | 5,600 rpm |
| (3) Kind of lubricant: | 10 W 30 |
| (4) Lubricant temperature: | 110° C. ± 5° C. |
| (5) Load: | 50 N/minute |

In the test for the pitting resistance, the samples were placed on a friction tester under a high load. Load (i.e., pressure) applied between the cam member having a cylindrical shape and the counterpart was kept constant. The pitting resistance was evaluated on the basis of a critical number of repeated load associated with the load at which pitting occurred (the number of repeated load N). Determination as whether or not the pitting occurred was made on the basis of results of operations of monitoring an unusual noise to be generated upon occurrence of the pitting and making an visual inspection of the sliding surface. The test conditions are as follows:

| | |
|---|---|
| (1) Material of the counterpart: | SUJ2 |
| (2) Number of revolutions: | 1,500 rpm |
| (3) Pressure: | 1,000 MPa |

Evaluation criteria for the scuffing resistance, the pitting resistance and the machinability of the Samples of the invention Nos. 1 to 28 and the Samples for comparison Nos. 1 to 12, in which the Sample for comparison No. 1 containing no solid lubricant was set as the lowest standard, were as follows:

In the scuffing resistance,

x: The scuffing resistance was comparable to that of the conventional cam member (i.e., 300N) or improved by a value of less than 10% of that of the conventional cam member.

Δ: The scuffing resistance was improved by a value within the range of from 10% to less than 20% of that of the conventional cam member, thus providing relatively good results.

∘: The scuffing resistance was improved by a value of over 20% of that of the conventional cam member, thus providing excellent results.

In the pitting resistance,

x: The pitting resistance was comparable to a value of less than 90% of that of the conventional cam member (N: 10⁷).

Δ: The pitting resistance was comparable to a value within the range of from 90% to 100% of that of the conventional cam member.

∘: The pitting resistance was comparable to a value of over 100% of that of the conventional cam member.

In the machinability,

x: The machinability was comparable to a value of less than 95% of that of the conventional cam member.

Δ: The machinability was comparable to a value within the range of from 95% to less than 100% of that of the conventional cam member.

∘: The machinability was comparable to a value of over 100% of that of the conventional cam member.

Results of Evaluation

Tables 1 and 2 also show the results of evaluation.

There was recognized that neither scuffing nor pitting occurred on the sliding surface of each of the cam members, which were provided on the camshafts of the Samples of the invention Nos. 1 to 28. On the contrary, there was recognized that at least one of scuffing and pitting occurred on the sliding surface of each of the cam members, which were provided on the camshafts of the Samples for comparison Nos. 1 to 12. The cam members, which were provided on the camshafts of the Samples of the invention Nos. 1 to 28, had an excellent machinability.

According to the present invention as described in detail, the cam member comprises the solid lubricant having an average particle size of up to 100 μm in an amount of 0.5 vol. % to 3.0 vol. %. It is therefore possible to reduce coefficient of friction between the cam member and the counterpart, thus improving the sliding properties. Consequently, it is possible to improve the scuffing resistance and the pitting resistance without applying the surface treatment as in the conventional prior art, and improve the machinability of the cam member. The cam member of the present invention, which has the pitting resistance and the scuffing resistance in the intermediate sliding system between the sliding contact system and the rolling contact system, is therefore suitably applicable to a sliding system in which the contact pressure with the counterpart is relatively high.

The camshaft of the present invention, which is provided with the cam member having the excellent scuffing resistance required for the cam member to be subjected to the sliding contact, as well as the excellent pitting resistance required for the cam member to be subjected to the rolling contact, is suitably applicable to the intermediate sliding system, in which the contact pressure with the counterpart is relatively high, between the sliding contact system and the rolling contact system. Accordingly, the camshaft of the present invention is suitably applicable to the sliding system in which a direct-hitting type tappet is used as the counterpart so that a cam-lifting distance is relatively large and the contact pressure of the sliding face of the cam member with the tappet is also relatively large.

The entire disclosure of Japanese Patent Application No. 2002-123627 filed on Apr. 25, 2002 including the specification, claims, drawings and summary is incorporated herein by reference in its entirety.

What is claimed is:

1. A cam member comprising solid lubricant having an average particle size of up to 100 μm in an amount of 0.5 vol. % to 3.0 vol. %.

2. The cam member as claimed in claim 1, wherein:
said solid lubricant is at least one selected from the group consisting of WS₂, CaF₂, BaF₂, BN, MnS, MoS₂, Cr₂O₃, MoO₃, B₂O₃ and MgSiO₃.

3. The cam member as claimed in claim 1, which is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: up to 1.0 vol. %; and
the balance being Fe and incidental impurities,
said sintered alloy having a matrix structure in which carbide is precipitated, said matrix structure mainly comprising pearlite.

4. The cam member as claimed in claim 1, which is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: up to 1.0 vol. %; and
the balance being Fe and incidental impurities,
said sintered alloy having a matrix structure in which carbide is precipitated, said matrix structure mainly comprising pearlite.

5. The cam member as claimed in claim 2, which is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: from over 1.0 vol. % to 2.5 vol. %; and
the balance being Fe and incidental impurities,
said sintered alloy having a matrix structure in which carbide is precipitated, said matrix structure mainly comprising martensite and bainite.

6. The cam member as claimed in claim 2, which is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: from over 1.0 vol. % to 2.5 vol. %; and
the balance being Fe and incidental impurities,
said sintered alloy having a matrix structure in which carbide is precipitated, said matrix structure mainly comprising martensite and bainite.

7. A camshaft comprising:
a main shaft; and
at least one cam member provided on said main shaft,
wherein:
each of said at least one cam member comprises solid lubricant having an average particle size of up to 100 μm in an amount of 0.5 vol. % to 3.0 vol. %.

8. The camshaft as claimed in claim 7, wherein:
said solid lubricant is at least one selected from the group consisting of WS₂, CaF₂, BaF₂, BN, MnS, MoS₂, Cr₂O₃, MoO₃, B₂O₃ and MgSiO₃.

9. The camshaft as claimed in claim 7, wherein:
each of said at least one cam member is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: up to 1.0 vol. %; and
the balance being Fe and incidental impurities,
said sintered alloy having a matrix structure in which carbide is precipitated, said matrix structure mainly comprising pearlite.

10. The camshaft as claimed in claim 8, wherein:
each of said at least one cam member is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: up to 1.0 vol. %; and
the balance being Fe and incidental impurities,
said sintered alloy having a matrix structure in which carbide is precipitated, said matrix structure mainly comprising pearlite.

11. The camshaft as claimed in claim 7, wherein:
each of said at least one cam member is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: from over 1.0 vol. % to 2.5 vol. %; and
the balance being Fe and incidental impurities,
said sintered alloy having a matrix structure in which carbide is precipitated, said matrix structure mainly comprising martensite and bainite.

12. The camshaft as claimed in claim 8, wherein:
each of said at least one cam member is formed of a sintered alloy having a chemical composition comprising:
C: from 1.5 vol. % to 3.8 vol. %;
Cr: from 2.0 vol. % to 20.0 vol. %;
Mo: from 0.5 vol. % to 3.0 vol. %;
Si: from 0.2 vol. % to 1.0 vol. %;
P: from 0.2 vol. % to 1.0 vol. %;
Ni: from over 1.0 vol. % to 2.5 vol. %; and
the balance being Fe and incidental impurities,
said sintered alloy having a matrix structure in which carbide is precipitated, said matrix structure mainly comprising martensite and bainite.
